(19) United States
(12) Patent Application Publication
(10) Pub. No.: US 2004/0094132 A1
(43) Pub. Date: May 20, 2004

(54) Evaporation fuel treating device

(76) Inventors: Hiroyuki Fujimoto, Obu-shi (JP); Ryuji Kosugi, Obu-shi (JP); Ryuji Kanemoto, Obu-shi (JP); Tokio Yamaguchi, Obu-shi (JP)

Correspondence Address: Oliff & Berridge, P O Box 19928, Alexandria, VA, 22320, US

(21) Appl. No.: 10/466,243

(22) PCT Filed: Feb. 5, 2002
(86) PCT No.: PCT/JP02/00940

(30) Foreign Application Priority Data
Feb. 9, 2001 (JP) 2001-077215

(51) Int. Cl. F02M 33/06

(52) U.S. Cl. 123/519

(57) ABSTRACT

It is an object to provide an evaporative fuel processing apparatus capable of enhancing a purging efficiency by heating a part of activated charcoal which can be heated more effectively and also restraining an increase in temperature of the activated charcoal to prevent a deterioration in adsorbing performance, and restraining electricity consumption. Heating devices (16a) and (16b) are placed at almost the midpoints of the adsorption material layers (7a) and (7b) respectively in a canister (1) to heat an adsorption material (4) for a predetermined time before start of purging. Accordingly, heating the part hard to purge can prompt the purging, thereby enhancing the purging efficiency and increasing the adsorbing capacity. Furthermore, the heating is stopped during the purging, so that the increase in temperature of the adsorption material (4) can be prevented, thereby preventing a deterioration in adsorbing performance at the time of adsorption of evaporative fuel.

### TECHNICAL FIELD

The present invention relates to an evaporative fuel processing apparatus for a motor vehicle and more particularly to improvements in a purging efficiency of a canister in the evaporative fuel processing apparatus.

### BACKGROUND ART

In a canister of an evaporative fuel processing apparatus constructed such that an adsorption material contained in the canister adsorbs evaporative fuel generated in a fuel tank during stop of an engine and thereafter the adsorbed evaporative fuel is purged by negative pressure in a suction pipe after the start of operation of the engine and then the evaporative fuel is combusted in a combustion chamber, it is desired to improve adsorbing capacity in view of demands for enhancement of emission control of evaporative fuel and reduction in size of the canister.

In Japanese patent unexamined publication No. Hei 1-147154, Japanese Utility Model unexamined publications Nos. Hei 2-131066, Hei 2-50160, and Sho 61-118956, and others, there have been disclosed canisters constructed, with an object to improve the adsorbing capacity of a canister, such that a heating device is provided in a canister to heat an adsorption material, thereby enhancing the efficiency of purging the evaporative fuel to increase the adsorbing capacity.

More specifically, according to Japanese patent unexamined publication No. Hei 1-147154, a heater is placed just under a filter to heat inflow air to about 60° C. to 80° C., thereby enhancing the volatilizing power of evaporative fuel adsorbed on activated charcoal. According to Japanese Utility Model unexamined publication No. Hei 2-131066, it is constructed to detect the temperature of an adsorption material layer varying according to a purge amount of fuel vapor adsorbed in the adsorption material layer, and turn off the power to a PTC heater upon completion of the purging. Accordingly, the temperature of the adsorption material layer in the canister is already low even immediately after stop of an engine so as to be advantageous for adsorption. When the adsorption is re-started, therefore, an adsorption amount of fuel vapor can be increased.

According to Japanese Utility Model unexamined publication No. Hei 2-50160, a space chamber is provided in a middle part of an activated charcoal chamber in a vessel and a heating body which heats when applied with an electric current is provided in the space chamber. The presence of the space chamber can prevent the heat generated when evaporative fuel is adsorbed onto activated charcoal from being directly transmitted to the activated charcoal positioned below, and can prevent a deterioration in adsorbing performance caused by a temperature increase of the activated charcoal positioned below. Furthermore, according to Japanese Utility Model unexamined publication No. Sho 61-118956, a charcoal canister provided with an intake port for taking in fuel vapor, a purge port for purging fuel vapor, and an air intake port for taking in the air to be used for purging, is constructed such that a PTC heater is mounted in the middle of the air intake port in order to improve adsorbing performance.

However, any of the above conventional heating devices is provided near an air intake port of the canister or in an air upstream part of the activated charcoal layer. About 80% of these parts would be purged by the taken air. Even if these parts are heated, the purging efficiency is low. In addition, the activated charcoal increased in temperature by heating may cause a deterioration in adsorbing performance at the stage of adsorbing the evaporative fuel. Furthermore, electricity consumption should be considered to be important. Consequentially, the present invention has been made to overcome the above mentioned problems and has an object to provide an evaporative fuel processing apparatus capable of enhancing the purging efficiency by heating a more effective part of activated charcoal in purging, also capable of preventing a deterioration in adsorbing performance by restraining an increase in temperature of the activated charcoal, and capable of restraining electricity consumption.

### DISCLOSURE OF INVENTION

An evaporative fuel processing apparatus according to the present invention made to overcome the above mentioned problems is characterized in an evaporative fuel processing apparatus using a canister including a heating device, the canister being provided with an adsorption material layer which adsorbs evaporative fuel generated from a fuel tank, and the adsorbed evaporative fuel being purged by negative pressure in an intake pipe in an engine, wherein the heating device is placed in almost a midstream of a path for the flow of air in the canister under purge.

Herein, the path for the flow of air in the canister under purge specifically means the path allowing air to flow from an air intake port to an evaporative fuel purge port. The midstream part means the midpoint of the path of air flowing from the air intake port to the evaporative fuel purge port. That is, it means almost the midpoint in a direction of height of the adsorption material layer in a single-bath type canister (see FIG. 14). In the case of a double-bath type canister, it means a lower part in a direction of height of each adsorption material layer, namely, almost the midpoint in a height direction between the adsorption material layers if linearly joined (see FIG. 1).

In this evaporative fuel processing apparatus, evaporative fuel generated in the fuel tank is allowed to flow in the canister and is sequentially adsorbed in the adsorption material layer. Then, the evaporative fuel adsorbed in the adsorption material layer is purged by negative pressure in the intake pipe of an engine. During this purging, air is taken in the canister through the air intake port. In the vicinity of the air intake port, therefore, about 80% of the evaporative fuel adsorbed in the adsorption material layer is purged by the taken air. More specifically, it is difficult to enhance the purging efficiency even if a heating device is provided near the air intake port. When the heating device is provided near the evaporative fuel intake port, on the other hand, the temperature of the adsorption material layer in this part largely increases. Accordingly, the temperature of the adsorption material layer in this part will not decrease even at re-adsorption after completion of purging, and the adsorbing performance of the adsorption material layer may be deteriorated.

In the evaporative fuel processing apparatus of the present invention, consequently, the heating device is provided near the midstream part of the path for the flow of air in the canister under purge. Heating the part which is the hardest to purge can prompt purging, thereby enhancing the purging efficiency and improving the adsorbing capacity. Furthermore, the increase in temperature of the adsorption material layer near the evaporative fuel intake port is restrained, so that adsorbing performance of the adsorption material layer can be prevented from deteriorating at the time of re-adsorption after completion of purging.

The evaporative fuel processing apparatus in another aspect of the present invention is characterized in an evaporative fuel processing apparatus using a canister including a heating device, the canister being provided with an adsorption material layer which adsorbs evaporative fuel generated from a fuel tank, and the adsorbed evaporative fuel being purged by negative pressure of an intake pipe in an engine, wherein the heating device is placed in almost a midstream of a path for the flow of air in the canister under purge, and the evaporative fuel processing apparatus further includes a control unit which turns the heating device into an on state to heat an adsorption material in the adsorption material layer for a predetermined time before start of the purging.

In this evaporative fuel processing apparatus, similarly, the heating device is provided near the midstream part of the path for the flow of air in the canister under purge. This makes it possible to effectively enhance the purging efficiency, restrain the increase in temperature of the adsorption material layer near the evaporative fuel intake port, and prevent a deterioration in adsorbing performance of the adsorption material layer at the time of re-adsorption after completion of purging.

Furthermore, in this evaporative fuel processing apparatus, the control unit turns on the heating device to heat the adsorption material of the adsorption material layer for a predetermined time prior to the start of purging. In other words, the adsorption material layer is pre-heated before start of purging. This makes it possible to efficiently heat the part of the adsorption material layer which is the hardest to purge, thereby prompting the purging to enhance the purging efficiency, and improving the adsorbing capacity. The control unit turns off the heating device during purging. This can further restrain the increase in temperature of the adsorption material layer and prevent the deterioration in adsorbing performance at the time of adsorption.

In the evaporative fuel processing apparatus according to the present invention, the heating device may be a heating element including a heat-radiating member, a tubular heater internally provided with a heating element, or a tubular heater constructed to allow exhaust heat or hot water to pass through the inside. Among them, the heating element having a heat-radiating member is preferably used, and the heating element is desirably a PTC element. This is because the PTC heater, which is self-controllable, can control the heating device with high accuracy.

In the evaporative fuel processing apparatus according to the present invention, in the case where the PTC heater is used as the heating element, the PTC heater having a Curie point temperature of 200° C. or more is preferably used. This makes it possible to increase the surface temperature of the heating device (the heater temperature) to 150° C. or more, thereby more effectively enhancing the purging efficiency. Since the surface temperature of the heating device is preferably increased to about 200° C., a PTC heater having a Curie point temperature of 240° C. is suitably used.

Furthermore, in the case of the evaporative fuel processing apparatus according to the present invention, having the control unit, the predetermined time for pre-heating may be determined as the time to be elapsed before the temperature of the heating device reaches a predetermined value. However, in the case where the heating device is the PTC heater provided with the heat-radiating member, the predetermined time for pre-heating is preferably determined as the time to be elapsed before the value of an electric current passing through the PTC heater becomes steady. In this way, it is possible to surely prevent the pre-heating from terminating even though the temperature increase of the heater is insufficient. As a result, the pre-heating of the adsorption material layer is fully conducted, thus sufficiently heating the part which is the hardest to purge, further prompting the purging and enhancing the purging efficiency.

### BRIEF DESCRIPTION OF DRAWINGS

FIG. 1 is a longitudinal sectional view of an evaporative fuel processing apparatus in a first embodiment according to the present invention;

FIG. 2 is a view for explaining placement positions of heaters;

FIG. 3 is a graph showing effects on a purging rate according to the placement positions of the heaters;

FIG. 4 is a graph showing effects on a purging rate according to Curie point temperatures of a PTC heater;

FIG. 5 is a graph showing changes in heater temperatures and heater currents with respect to the time for application of an electric current in the case of using a PTC element having a Curie point temperature of 125° C.;

FIG. 6 is a graph showing changes in heater temperatures and heater currents with respect to the time for application of an electric current in the case of using a PTC element having a Curie point temperature of 180° C.;

FIG. 7 is a graph showing changes in heater temperatures and heater currents with respect to the time for application of an electric current in the case of using a PTC element having a Curie point temperature of 240° C.;

FIG. 8 is a flowchart showing the details of heater control (heater current control) by a control unit;

FIG. 9 is a flowchart showing the details of heater control (heater temperature control) by the control unit;

FIG. 10 is a flowchart showing the details of heater control (timer control) by the control unit;

FIG. 11 is a graph showing results of a performance comparative test using the evaporative fuel processing apparatus in the first embodiment;

FIG. 12 is a longitudinal sectional view of an evaporative fuel processing apparatus in a second embodiment according to the present invention;

FIG. 13 is a longitudinal sectional view of an evaporative fuel processing apparatus in a third embodiment according to the present invention; and

FIG. 14 is a longitudinal sectional view of an evaporative fuel processing apparatus (single-bath type) in another embodiment.

### BEST MODE FOR CARRYING OUT THE INVENTION

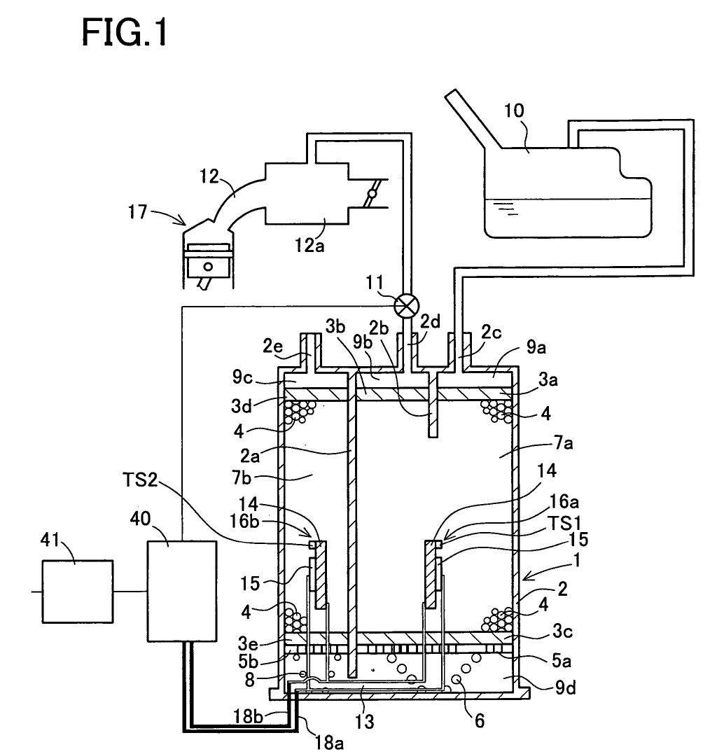

A detailed description of a preferred embodiment of a processing apparatus embodying the present invention will now be given referring to the accompanying drawings. FIG. 1 is a longitudinal sectional view of an evaporative fuel processing apparatus in a first embodiment of the present invention. In FIG. 1, the inside of a case 2 of a canister 1 is divided by a partition wall 2a. In one of the insides divided into two, a first adsorption material layer 7a is constructed of an adsorption material 4 tightly held between breathable filters 3a, 3b, and 3c under pressure by a spring 6 through a breathable plate 5a. In the other, similarly, a second adsorption material layer 7b is constructed of an adsorption material 4 tightly held between breathable filters 3d and 3e under pressure by a spring 8 through a breathable plate 5b.

In a first space 9a defined by the case 2, the filter 3a, and a dividing plate 2b, a tank port 2c communicating with the top of a fuel tank 10 is open. In a second space 9b defined by the case 2, the partition wall 2a, the filter 3b, and the dividing plate 2b, a purge port 2d communicating with a surge tank 12a of an intake pipe 12 through an electromagnetic opening/closing valve 11 is open. Furthermore, in a third space 9c defined by the case 2, the filter 3d, and the partition wall 2a, an air port 2e communicating with the atmosphere is open.

The electromagnetic opening/closing valve 11 in this embodiment is connected to a control unit 40. This control unit 40, as mentioned later, carries out ON/OFF control of power to PTC heaters 16a and 16b in addition to opening/closing control of the electromagnetic valve 11. The control unit 40 is connected to an ECU 41 and executes various controls based on signals from the ECU 41.

A communication passage 13 is formed at an end portion of the partition wall 2a and a fourth space 9d is defined by the case 2, the plates 5a and 5b. Thus, the adsorption material layers 7a and 7b are arranged in series with each other via the fourth space 9d. Assuming that the first and second adsorption material layers 7a and 7b are constructed linearly (in series), a first and second PTC heaters 16a and 16b each including a PTC heater 15 held in contact with a heating member 14 are placed at almost the midpoint (in FIG. 1, the lower parts of the adsorption material layers 7a and 7b). The first PTC heater 16a is placed at almost the midpoint even in a width direction of the first adsorption material member 7a (in a lateral direction in FIG. 1). Similarly, the second PTC heater 16b is placed at almost the midpoint in a width direction of the second adsorption material member 7b (in a lateral direction in FIG. 1). The first and second PTC heaters 16a and 16b are placed in direct contact with the adsorption materials 4 of the adsorption material layers 7a and 7b respectively.

Both the PTC heaters 16a and 16b are connected to the control unit 40 through conducting wires 18a and 18b. With this structure, based on a signal from the ECU 41, the control unit 40 turns on/off the power to the PTC heaters 16a and 16b.

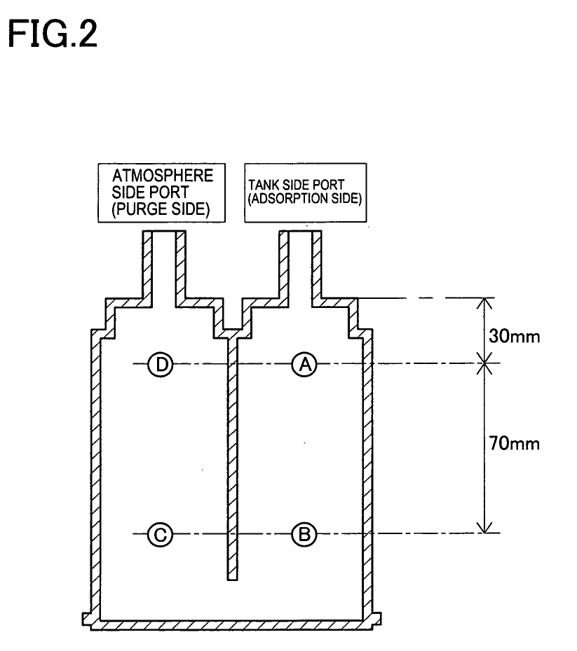

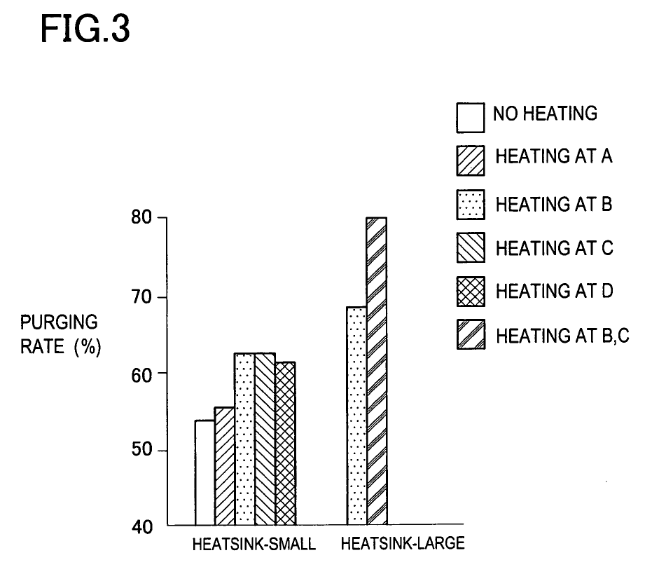

The effects on the purging rate according to the positions of the first and second PTC heaters 16a and 16b are explained below with reference to FIGS. 2 and 3. It is to be noted that the purging rate is expressed (similarly in the following explanation) by “(Purging amount/Adsorption amount)×100”. FIG. 2 is a view showing the positions of the heaters. In FIG. 2, A to D indicate the positions of the heaters. The positions B and C correspond to the positions of the first and second PTC heaters 16a and 16b in the present embodiment. FIG. 3 is a view showing the purging rate when each heater placed in each position shown in FIG. 2 is heated. “Heatsink—Large” shows the case where the heat-radiating member 14 is arranged over almost the entire area of the canister 1 in a depth direction thereof (in a direction perpendicular to the sheet of FIG. 1) and “Heatsink Small” shows the case where the area is about one-third (with a reduced depth size and the same height) the area in the case of the “Heatsink Large”.

As seen in FIG. 3, when the heaters are placed at the positions B and C, the purging rate could be increased. In other words, the first PTC heater 16a is placed at the position B and the second PTC heater 16b is placed at the position C, so that the purging efficiency could be enhanced. Placement in those positions can restrain the increase in temperature of the adsorption material 4 in the upper part of the first adsorption material layer 7a (on the side which evaporative fuel is introduced into). It is therefore possible to prevent a deterioration in adsorbing performance of the adsorption material 4 at the time of re-adsorption after completion of purging.

As seen in FIG. 3, the purging rate is larger in the case where the heat-radiating member 14 is disposed over almost the entire area of the canister 1 in the depth direction (in a direction perpendicular to the sheet of FIG. 1). In the present embodiment, accordingly, the heat-radiating member 14 is placed over almost the entire area of the canister 1 in the depth direction (in a direction perpendicular to the sheet of FIG. 1). With this structure, the purging rate can further be enhanced. It is to be noted that an aluminum plate is used as the heat-radiating member 14. This is because the heat deriving from the PTC element 15 can be conducted rapidly and uniformly. Any metallic materials having such properties and resistance to corrosion by evaporative fuel, besides the aluminum plate, can be used as the heat-radiating member 14.

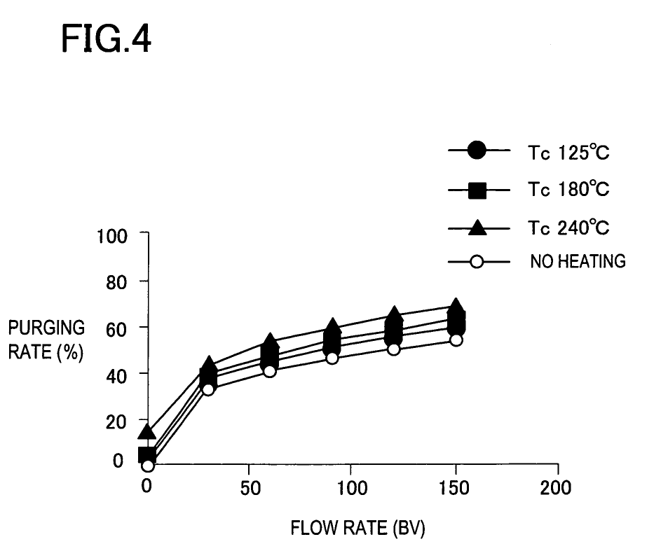

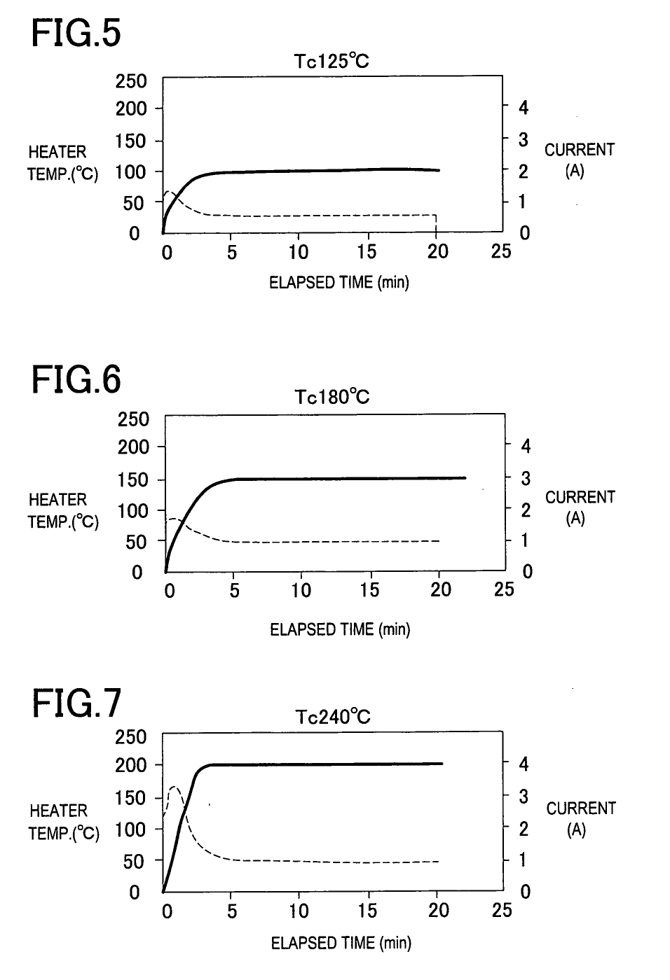

Subsequently, the effects on the purging rate according to the Curie point temperatures of the PTC element 15 are explained with reference to FIG. 4. FIG. 4 is a graph showing the purging rates obtained when the PTC elements having three different Curie point temperatures (Curie point temperatures: 125° C., 180° C., and 240° C.) are placed and heated at the position B in FIG. 2. In the case of using the PTC element having a Curie point temperature of 125° C., the surface temperature (heater temperature) of the heat-radiating member 14 reaches about 100° C. as shown in FIG. 5. In the case of using the PTC element having a Curie point temperature of 180° C., the surface temperature (heater temperature) of the heat-radiating member 14 reaches about 140° C. as shown in FIG. 6. In the case of using the PTC element of a Curie point temperature of 240° C., the surface temperature (heater temperature) of the heat-radiating member 14 reaches about 200° C. as shown in FIG. 7.

As clearly seen in FIG. 4, the higher Curie point temperature provides the higher purging rate. In the present embodiment, therefore, the PTC element 15 having a Curie point temperature of 240° C. is used so that the surface temperature (heater temperature) of the heat-radiating member 14 reaches about 200° C. It is to be noted that the optimal surface temperature of the heat-radiating member 14 is about 200° C.; however, the purging efficiency can be enhanced if only the temperature is 150° C. (a Curie point temperature of 200° C.) or more.

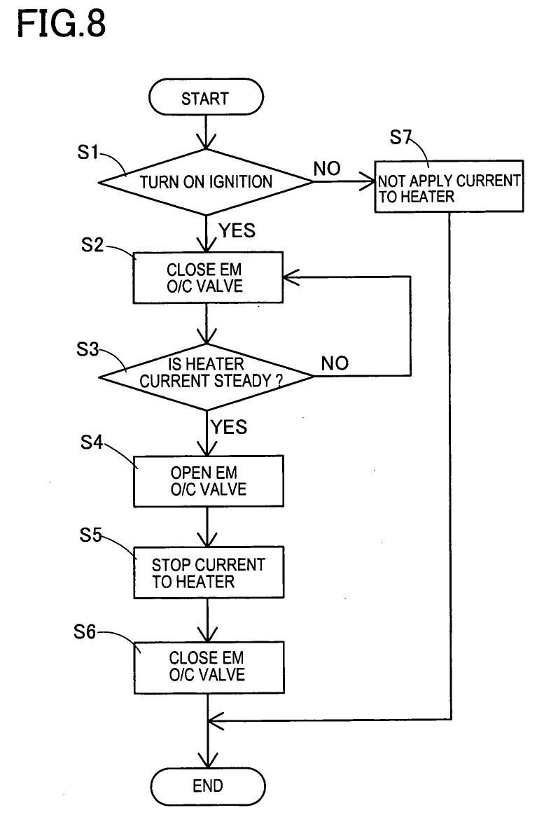

Next, the operation of the present embodiment having the above structure is explained with reference to the flowchart shown in FIG. 8. When an engine 17 is stopped and the temperature of the fuel tank 10 is increased, the evaporative fuel generated in the fuel tank 10 is allowed to pass through a check valve not shown and flow in the canister 1 through the tank port 2c. The evaporative fuel flowing in the canister 1 is sequentially adsorbed onto the adsorption materials 4 in the first and second adsorption material layers 7a and 7b. Thus, the evaporative fuel generated in the fuel tank 10 will not leak out to the atmosphere through the air port 2e.

Upon turn-on of an ignition switch not shown of the engine 17 to activate the engine 17 (S1: YES), the ECU 41 receives an ON signal from the ignition switch. Then, the ECU 41 transmits an electromagnetic opening/closing valve ON signal to the control unit 40. Upon receipt of this signal, the control unit 40 turns on the power to the electromagnetic opening/closing valve 11. The electromagnetic opening/closing valve 11 is thus closed (S2). At the same time with this, the control unit 40 also controls to turn on the power to the first and second PTC heaters 16a and 16b based on the signal from the ECU 41. Accordingly, the application of an electric current to the first and second PTC heaters 16a and 16b is started, starting pre-heating of the adsorption materials 4. At this time, the control unit 40 measures values of the electric current passing through the first and second PTC heaters 16a and 16b.

In the case where the ignition switch is not turned on (S1: NO), on the other hand, an electric current is not applied to the first and second PTC heaters 16a and 16b (S7).

Thereafter, the control unit 40 determines whether the electric current passing through the first and second PTC heaters 16a and 16b has become steady (S3). When it is determined that the value of the electric current has become steady (S3: YES), the control unit 40 turns off the power to the electromagnetic opening/closing valve 11. Accordingly, the electromagnetic opening/closing valve 11 is opened (S4) and purging of the canister 1 is thereby started. When the value of the electric current passing through the first and second PTC heaters 16a and 16b has not become steady (S3: NO), on the other hand, the apparatus is placed in a standby condition.

Upon open of the electromagnetic opening/closing valve 11, then, the control unit 40 turns off the power to the first and second PTC heaters 16a and 16b, thus stopping heating of the adsorption material 4 (S5). The pre-heating is terminated.

During the above pre-heating, the adsorption material 4 in each of the adsorption material layers 7a and 7b is heated, so that the evaporative fuel adsorbed on the adsorption material 4 is evaporated, permeating each of the adsorption material layers 7a and 7b. Upon start of the purging, the evaporative fuel permeating the adsorption material layers 7a and 7b is sucked therefrom to the engine 17. Thus, the purging efficiency can be enhanced. The temperature of the evaporative fuel to be sucked has been increased by the pre-heating, which increases the temperature of the adsorption material 4 more than that in the conventional apparatus when the evaporative fuel passes through the adsorption material layers 7a and 7b. Accordingly, the purging efficiency can further be enhanced.

Subsequently, after completion of the purging, the control unit 40 causes the electromagnetic opening/closing valve 11 to be closed again (S6). It is to be noted that the pre-heating is terminated before the permeating evaporative fuel leaks out to the atmosphere through the air port 2e, and therefore the leakage of the evaporative fuel to the atmosphere due to the heating can be prevented.

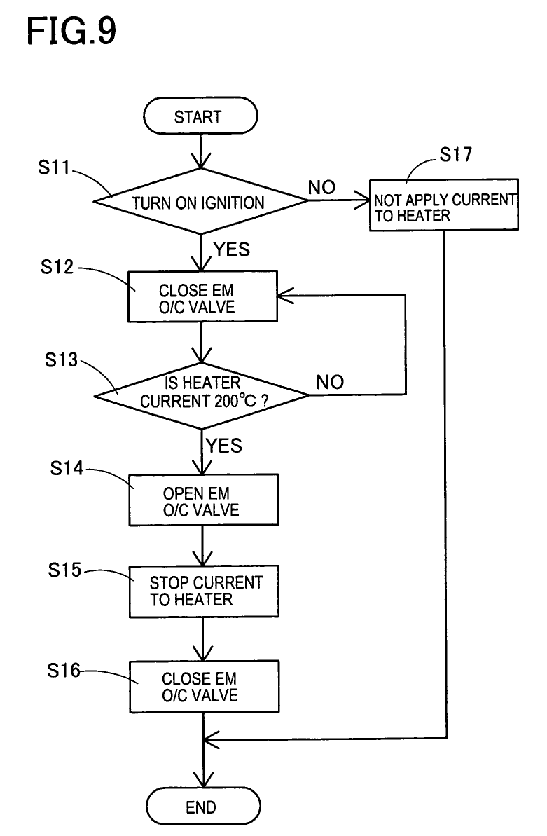

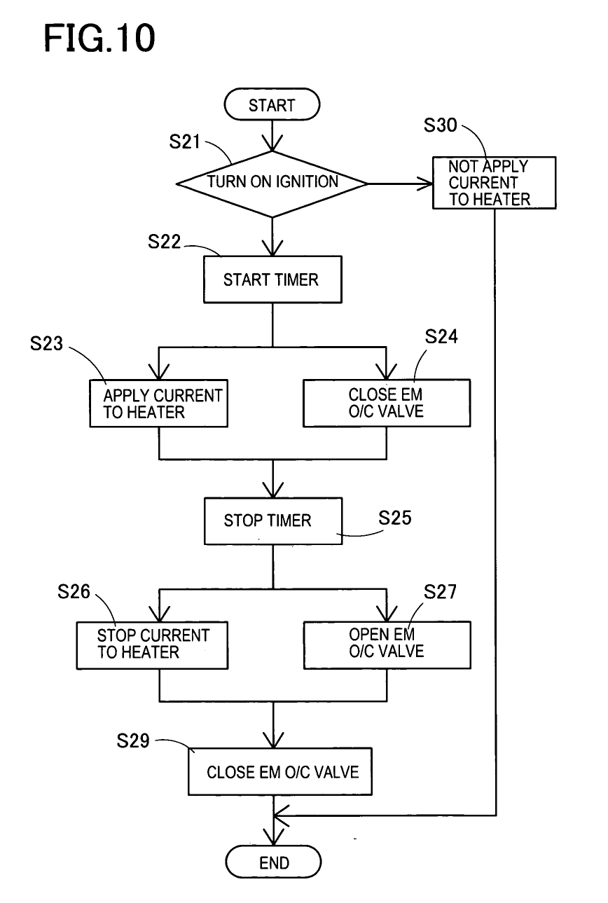

In the present embodiment, the time for pre-heating is determined as the time that elapses before the value of the electric current passing through the first and second PTC heaters 16a and 16b becomes steady; alternatively, the time for pre-heating may be determined according to other manners. Controls of the time for pre-heating according to the other manners are explained with the use of flowcharts shown in FIGS. 9 and 10.

The control shown in FIG. 9 includes detecting the temperatures of the first and second PTC heaters 16a and 16b and then terminating the pre-heating at the time when the detected temperatures reach a predetermined value (200° C.). To execute this control, a temperature sensor TS1 is attached to the heat-radiating member 14 of the first PTC heater 16a and a temperature sensor TS2 is attached to the heat-radiating member 14 of the second PTC heater 16b (see FIG. 1). Hence, the temperatures of the first and second PTC heaters 16a and 16b here means the surface temperatures of the heat-radiating members 14. Output signals from the temperature sensors TS1 and TS2 are transmitted to the control unit 40. It is to be noted that the temperature sensors may be attached to the PCT elements 15, instead of being attached to the heat-radiating members 14.

The details of the control are explained below. When the engine 17 is stopped and the temperature of the fuel tank 10 is increased, the evaporative fuel generated in the fuel tank 10 is allowed to pass through a check valve not shown and flow in the canister 1 through the tank port 2c. The evaporative fuel flowing in the canister 1 is sequentially adsorbed onto the adsorption materials 4 in the first and second adsorption material layers 7a and 7b.

When the ignition switch not shown of the engine 17 is turned on to activate the engine 17 (S11: YES), the ECU 41 receives an ON signal of the ignition switch. And, the ECU 41 transmits an ON signal for electromagnetic opening/closing valve to the control unit 40. Upon receipt of this signal, the control unit 40 turns on the power to the electromagnetic opening/closing valve 11 to close the valve 11 (S12). Simultaneously, the control unit 40 controls to turn on the power to the first and second PTC heaters 16a and 16b in response to the signal from the ECU 41. Thus, the application of an electric current to the first and second PTC heaters 16a and 16b is started, thereby starting heating (pre-heating) of the adsorption material 4. At this time, the control unit 40 measures the temperatures of the first and second PTC heaters 16a and 16b. To be more precise, based on the output signals from the temperature sensors TS1 and TS2, the control unit 40 measures the surface temperatures of the heat-radiating members 14, 14 provided in the first and second PTC heaters 16a and 16b.

It is to be noted that when the ignition switch is not turned on (S11: NO), an electric current is not applied to the first and second PTC heaters 16a and 16b (S17).

Then, the control unit 40 determines whether the temperatures of the first and second PTC heaters 16a and 16b have reached 200° C. (S13). This determination is performed based on the output signals from the temperature sensors TS1 and TS2 attached to the heat-radiating members 14 and 14 provided in the first and second PTC heaters 16a and 16b.

When determines that the temperatures of the first and second PTC heaters 16a and 16b have reached 200° C. (S13: YES), the control unit 40 turns off the power to the electromagnetic opening/closing valve 11 to open the valve 11 (S14), thereby starting the purging of the canister 1. When the temperatures of the first and second PTC heaters 16a and 16b have not reached 200° C. (S13: NO), the apparatus is placed in a standby condition.

Upon open of the electromagnetic opening/closing valve 11, the control unit 40 turns off the power to the first and second PTC heaters 16a and 16b, stopping the heating of the adsorption materials 4 (S15). Thus, the pre-heating is terminated. After completion of the purging, thereafter, the control unit 40 causes the electromagnetic opening/closing valve 11 to be closed again (S16).

By this control, similarly, the adsorption material 4 in each adsorption material layer 7a, 7b is heated during the pre-heating. Accordingly, the evaporative fuel adsorbed on the adsorption material 4 is evaporated to permeate each adsorption material layer 7a, 7b. Upon start of the purging, the evaporative fuel permeating each adsorption material layer 7a, 7b is sucked therefrom to the engine 17. Hence, the purging efficiency can be enhanced. The temperature of the evaporative fuel to be sucked has been increased by the pre-heating, which increases the temperature of the adsorption materials 4 more than that in the conventional apparatus when the evaporative fuel passes through the adsorption material layers 7a and 7b. The purging efficiency can further be enhanced.

The control shown in FIG. 10 is arranged to terminate the pre-heating with the use of a timer. The details thereof are explained below. When the engine 17 is stopped and the temperature of the fuel tank 10 is increased, the evaporative fuel generated in the fuel tank 10 is allowed to pass through the check valve not shown to flow in the canister 1 through the tank port 2c. The evaporative fuel flowing in the canister 1 is sequentially adsorbed onto the adsorption materials 4 in the first and second adsorption material layers 7a and 7b.

When the ignition switch not shown of the engine 17 is turned on to activate the engine 17 (S21: YES), the ECU 41 receives an ON signal of the ignition switch. Then, the ECU 41 transmits a timer start signal to the control unit 40. Upon receipt of this signal, the control unit 40 starts clocking of the timer (S22). Simultaneously, the control unit 40 starts to apply an electric current to the first and second PTC heaters 16a and 16b (S23) and closes the electromagnetic opening/closing valve 11 (S24). Thus, the heating (pre-heating) of the adsorption materials 4 is started.

It is to be noted that when the ignition switch is not turned on (S21: NO), an electric current is not applied to the first and second PTC heaters 16a and 16b (S30).

Then, when the clocking of the timer is terminated (S25), the control unit 40 stops the application of the electric current to the first and second PTC heaters 16a and 16b (S26), which stops the heating of the adsorption material 4. Thus, the pre-heating is terminated.

The control unit 40 causes the electromagnetic opening/closing valve 11 to be opened (S27) to start the purging of the canister 1. After completion of the purging, the control unit 40 causes the electromagnetic opening/closing valve 11 to be closed again (S16).

By this control, similarly, the adsorption material 4 in each adsorption material layer 7a, 7b is heated during the pre-heating, so that the evaporative fuel adsorbed on the adsorption material 4 is evaporated to permeate each adsorption material layer 7a, 7b. Upon start of the purging, the evaporative fuel permeating each adsorption material layer 7a, 7b is sucked therefrom to the engine 17. Consequently, the purging efficiency can be enhanced. The temperature of the evaporative fuel to be sucked has been increased by the pre-heating, which increases the temperature of the adsorption material 4 more than that in the conventional apparatus when the evaporative fuel passes through the adsorption material layers 7a and 7b, the purging efficiency can further be enhanced.

The clocking time of the timer is previously determined at an optimum value by experiment. The determined value is stored in the control unit 40. More specifically, the clocking time of the timer is set at about 10 min. This is because it takes about 5 min. to increase the heater temperature to a predetermined temperature, as shown in FIGS. 5 to 7; however, the current values are not always steady at that time. Consequently, the time to allow a determination that the current value has become completely steady and the heater temperature has been increased sufficiently is set at 10 min.

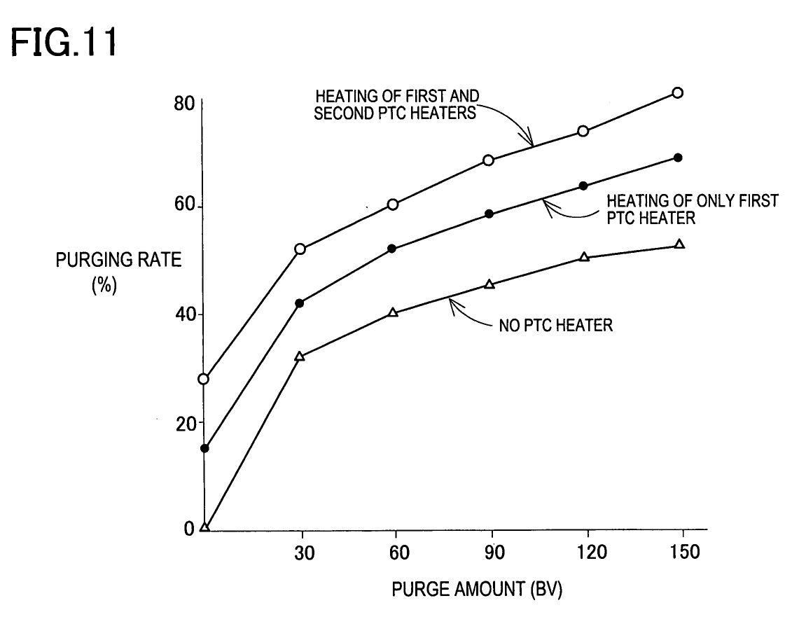

Next explanation is made on results of a performance comparative test between the evaporative fuel processing apparatus in the present embodiment and the conventional evaporative fuel processing apparatus. FIG. 11 is a graph showing the results of the comparative test using the evaporative fuel processing apparatus in the present embodiment. The total volume of the adsorption material layers in the canister subjected to the comparative test was 500 cc, at a volume ratio of 1:1 between the first and second adsorption material layers 7a and 7b. At first, a test procedure is explained. As an adsorption condition, butane was adsorbed by up to 65.5 g at a flow rate of 0.2 l/min. After the pre-heating of 10 min. duration, nitrogen gas was then used to purge at a flow rate of 3.0 l/min. and the purging rate was measured every 30 BV (Bet Volume) up to the total flow rate of 150 BV. It is to be noted that the BV value indicates a multiple of the total volume of the canister, and “30BV” means “30×500 cc=15 l(liters)”.

The conventional canister using no PTC heater (indicated by a solid line with white triangles) shows the lowest purging rate, about 50%, with respect to the purge amount of 150 BV. In the case (indicated by a solid line with black circles) where only the first PTC heater 16a provided in the first adsorption material layer 7a was operated for heating, the purging rate was larger than the conventional one, namely, about 65%, with respect to the purge amount of 150 BV. In the present embodiment, namely, the case (indicated by a solid line with white circles) where both the first PTC heater 16a placed in the first adsorption material layer 7a and the second PTC heater 16b placed in the second adsorption material layer 7b were operated for heating, the purging rate is far larger, namely, about 80%, with respect to the purge amount of 150 BV. It has been found that the best placing positions of the PTC heaters 16a and 16b are almost the midpoints in height, which is lower by about 70% from the upper ends of the adsorption material layers 7a and 7b, i.e., slightly lower than the midpoints, and the purging rates are reduced as the positions become higher, namely, the midpoints, and the positions lower by about 30% from the upper ends, in sequence.

To obtain the purging rate of for example 50%, the conventional canister using no PTC heater would need the purge amount of 150 BV. The canister 1 in the present embodiment, on the other hand, needs only the purge amount of about 30BV. In other words, the canister 1 in the present embodiment can reduce the purge amount to about one-fifth. This makes it possible to reduce the amount of the adsorption materials 4 in the canister, and furthermore to achieve a reduction in size of the canister.

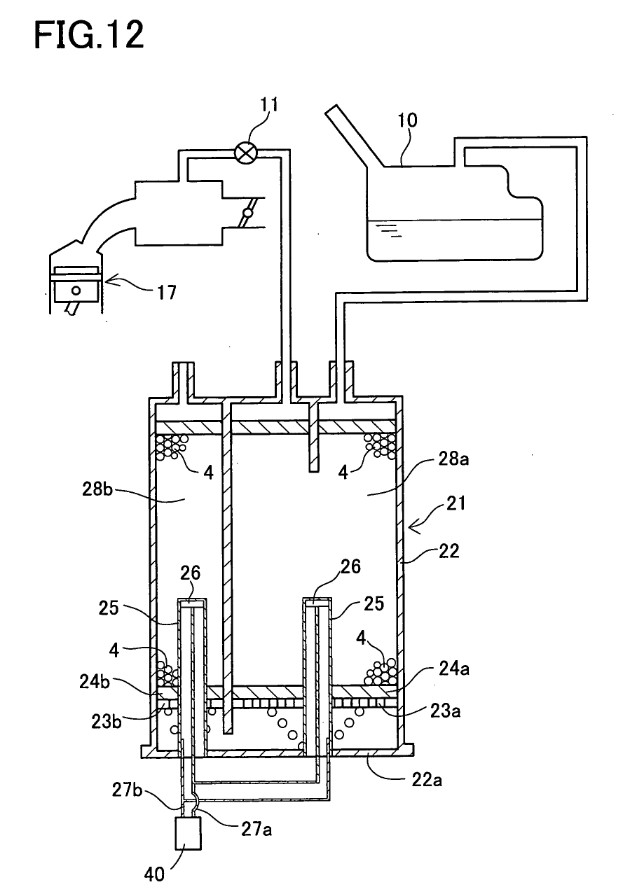

Next, a second embodiment of the present invention is explained about only differences from the first embodiment. FIG. 12 is a longitudinal sectional view of an evaporative fuel processing apparatus in the second embodiment of the present invention. In FIG. 12, a canister 21 is constructed of a case 22 with a bottom wall 22a on which high-heat-conductivity metal pipes 25 each having a bottom are provided in an upright position, penetrating plates 23a and 23b and filters 24a and 24b respectively. Inside of the bottom of each pipe 25, a heating element 26 is provided in connection to a control unit 40 through a conducting wire 27a or 27b. The heating elements 26 are constructed to be turned on/off under the control of the control unit 40 to heat the adsorption materials 4 in a first adsorption material layer 28a and a second adsorption material layer 28b. In this manner, the heating elements 26 are not directly exposed to the evaporative fuel, which provides superior resistance to rust and high safety. The operation and effects in the present embodiment are the same as those in the first embodiment and not explained herein.

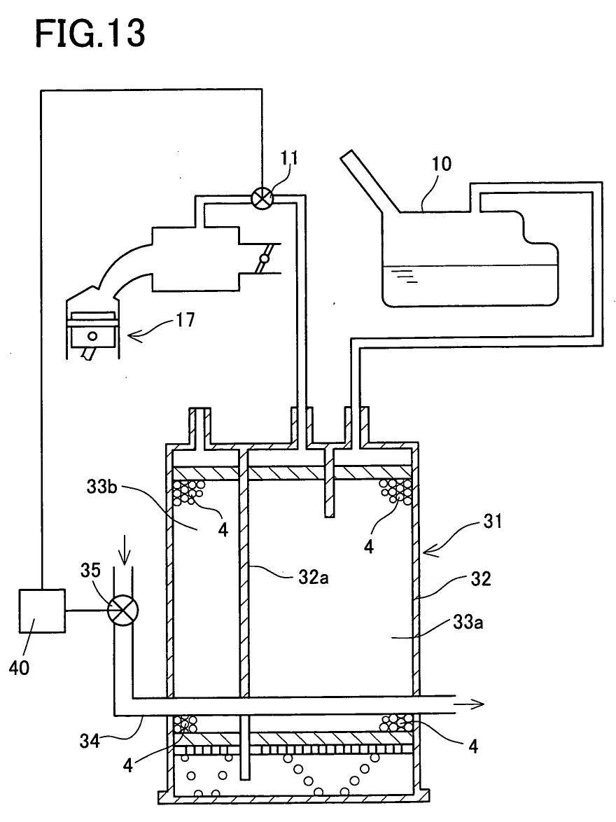

Next, a third embodiment of the present invention is explained about only differences from the first embodiment. FIG. 13 is a longitudinal sectional view of an evaporative fuel processing apparatus in the third embodiment of the present invention. In FIG. 13, a canister 31 is constructed of a case 32 in which a metal pipe 34 having high heat-conductivity is provided penetrating a first adsorption material layer 33a, a partition wall 32a, and a second adsorption material layer 33b. The pipe 34 is constructed to allow the cooling water used for cooling an engine or the air heated by an exhaust pipe to flow as indicated by an arrow, thereby heating the adsorption materials 4 by that heat. At an upstream part in the pipe 34, an electromagnetic opening/closing valve 35 is provided to open/close a pipe flow passage. The valve 35 is wired to the control unit 40 and is turned on/off under the control of the control unit 40.

The operation of the present embodiment is explained below. When the ignition switch not shown of the engine 17 is turned on to activate the engine 17, the control unit 40 turns on the electromagnetic opening/closing valve 11 in response to the ON signal of the ignition switch to close the valve 11, thus stopping the purging. When the temperature sensor not shown detects that the engine 17 has been warmed up and the cooling water temperature or the exhaust pipe temperature has reached a predetermined temperature, the power of the electromagnetic opening/closing valve 35 provided in the pipe 34 is turned on under the control of the control unit 40 based on the detection signal, and the valve 35 is thus opened. The adsorption material 4 are then heated by the cooling water or the air heated by the exhaust pipe which passes through the pipe 34. After a lapse of a predetermined time from turn-on of the ignition switch, the power to the electromagnetic opening/closing valve 11 is turned off to open the valve 11, starting the purging of the canister 31. Simultaneously, the power to the electromagnetic opening/closing valve 35 in the pipe 34 is turned off to close the valve 35, thus stopping the heating of the adsorption material 4. Consequently, the same effects can be obtained as in the first and second embodiments.

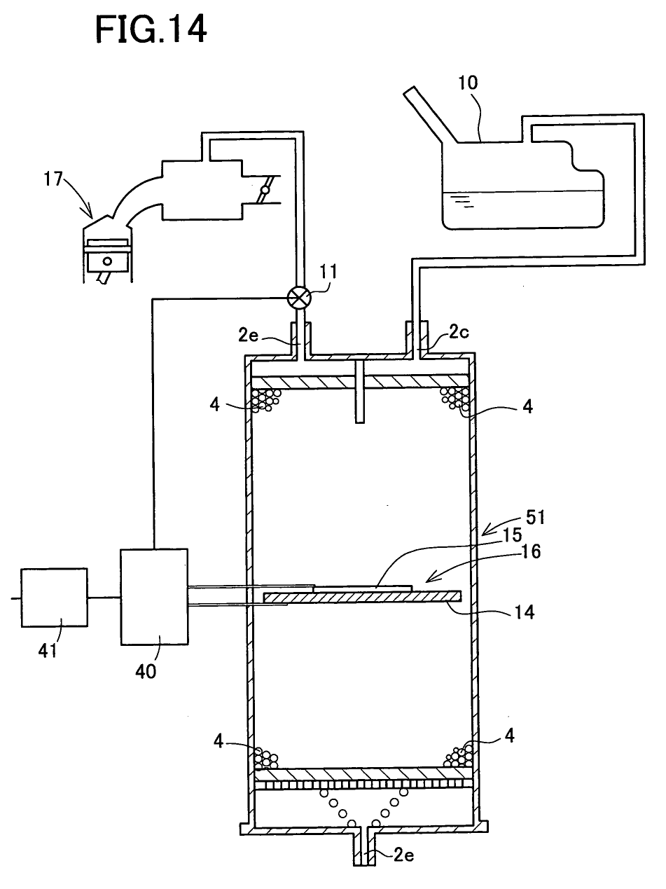

Note that the above embodiments are mere exemplifications and do not provide any limitation to the present invention. The present invention may be embodied in other specific forms without departing essential characteristics thereof. For instance, the double-bath type canister is exemplified in the above explanations; however, the present invention, not limited to the double-bath type canister, may be applied to a single-bath type canister 51 shown in FIG. 14. In this case, a PTC heater 16 constructed of a heat-radiating member 14 and a PTC element 15 is placed at the midpoint in the height direction of the canister 51.

Furthermore, the PTC heater is utilized as the heating device, but the heating device is not limited to the PTC heater. Specifically, a tungsten heater molded of ceramics, a silicon carbide heater, and others can also be used.

Although the control unit 40 is connected to the ignition switch through the ECU 41, it may be connected directly to the ignition switch, not through the ECU 41. Alternatively, the control unit 40 may be incorporated in the ECU 41. Even in this case, the above mentioned heater control can be performed.

Additionally, it will be obvious that the concrete values exemplified in the above embodiments are mere exemplifications.

### INDUSTRIAL APPLICABILITY

As evidenced by the above explanations, the present invention is structured to provide the heating device at almost the midpoint of the adsorption material layer in the canister to heat the adsorption materials for a predetermined time before start of purging. Accordingly, heating the part hard to purge can prompt the purging, thereby enhancing the purging efficiency and increasing the adsorption capacity. The heating is stopped during the purging, so that the increase in temperature of the adsorption materials can be prevented, which also makes it possible to prevent a deterioration in the adsorption performance at the time of adsorption.

1. An evaporative fuel processing apparatus using a canister including a heating device, the canister being provided with an adsorption material layer which adsorbs evaporative fuel generated from a fuel tank, and the adsorbed evaporative fuel being purged by negative pressure in an intake pipe in an engine,
wherein the heating device is placed in almost a midstream of a path for the flow of air in the canister under purge.

2. An evaporative fuel processing apparatus using a canister including a heating device, the canister being provided with an adsorption material layer which adsorbs evaporative fuel generated from a fuel tank, and the adsorbed evaporative fuel being purged by negative pressure of an intake pipe in an engine,
wherein the heating device is placed in almost a midstream of a path for the flow of air in the canister under purge, and
the evaporative fuel processing apparatus further includes a control unit which turns the heating device into an on state to heat an adsorption material in the adsorption material layer for a predetermined time before start of the purging.

3. The evaporative fuel processing apparatus according to claim 1 or 2, wherein the heating device is a heating element including a heat-radiating member.

4. The evaporative fuel processing apparatus according to claim 3, wherein the heating element is a PTC heater.

5. The evaporative fuel processing apparatus according to claim 4, wherein the PTC heater is of a Curie point temperature of 200° C. or more.

6. The evaporative fuel processing apparatus according to claim 2, wherein the heating device is a PTC heater including a heat-radiating member, and
the predetermined time is the time to be elapsed before a value of an electric current passing through the PTC heater becomes steady.

7. The evaporative fuel processing apparatus according to claim 2, wherein the predetermined time is the time to be elapsed before a temperature of the heating device reaches a predetermined value.

8. The evaporative fuel processing apparatus according to claim 1 or 2, wherein the heating device is a tubular heater internally provided with a heating element.

9. The evaporative fuel processing apparatus according to claim 1 or 2, wherein the heating device is a tubular heater constructed to allow exhaust heat or hot water to pass through the inside.
